(19) United States
(12) Patent Application Publication
(10) Pub. No.: US 2009/0128139 A1
(43) Pub. Date: May 21, 2009

(54) MAGNET POSITION LOCATOR

(76) Inventors: Joseph B. Drenth, Chalfont, PA (US); Ronald R. Drenth, Chalfont, PA (US)

Correspondence Address: WILLIAMS, MORGAN & AMERSON, 10333 RICHMOND, SUITE 1100, HOUSTON, TX, 77042, US

(21) Appl. No.: 11/943,100

(22) Filed: Nov. 20, 2007

(51) Int. Cl. G01B 7/14

(52) U.S. Cl. 324/207.22; 324/207.26

(57) ABSTRACT

In one illustrative embodiment, the present subject matter is directed to a device adapted to determine the position of a target magnet, wherein the device includes a pair of orthogonal magnetic field sensors laterally disposed along an axis that is substantially transverse to an axis defined by one that is nominally parallel to the direction of the target magnet. In another illustrative embodiment, the subject matter is adapted for use on an automated guided vehicle (AGV), whereby detection of the target magnet's location facilitates correction of the vehicle's heading and position while traversing an AGV system. The present subject matter is also directed to a method whereby the position of a target magnet may be determined by triangulation, utilizing trigonometric calculations based upon the strength and direction of the magnet field to determine the magnet's position relative to the magnetic field sensors.

### BACKGROUND OF THE INVENTION

1. Field of the Invention

The present invention generally relates to the field of magnetic field sensing and, more particularly, to devices used for magnetic field sensing, detecting the location of magnets, and various methods of using same.

2. Description of the Related Art

Many types of industrial activities, such as manufacturing, packaging, warehousing and shipping, often employ driverless vehicles to perform a variety of movement-related functions. Depending on the industry and application, the types of activities performed by these driverless vehicles are commonly repetitive in nature, and the vehicles would generally be expected to continue these activities within a pre-defined set of operating parameters without significant human interaction or monitoring. Such repetitive and unmonitored activities would include for example: material handling within a factory setting, whereby raw materials or components are moved between locations, machines, or stations to facilitate further steps in a manufacturing process; moving parts through various stages of assembly, inspection, testing or packaging; transporting or depositing materials or finished products in bins, crates, racks or shelves for temporary storage or inventory; and moving materials, products, or packages between various facilities, buildings or locations for purposes of furthering the manufacturing, packaging, storing, or shipping process.

One type of driverless vehicle that is often used to perform the activities described above is an automated guided vehicle (AGV). An AGV is commonly used in conjunction with a guide system that provides either continuous or intermittent navigational corrections to the vehicle so as to maintain its intended path and activity. Automated guided vehicles are used in many industries, and have become highly effective in transporting materials and products within a factory environment so as to facilitate, for example, a manufacturing process. In some applications, a plurality of AGV's is utilized to automatically carry loads from a pickup point to a discharge point along a pre-determined system guide path. Navigation of AGV's is performed by a variety of methods, which by way of example include guidance systems utilizing fixed guide wires, magnetic field sensing, and dead-reckoning. Each of these typical navigation or guidance systems are discussed briefly below so as to provide background information on some of the prior art methods employed in the steering of AGV's.

In a typical fixed guide wire system, an AC current is passed through a guide wire or cable that has been arranged in a path or roadway for the purpose of generating a magnetic field around the guide cable. In such a navigational system, the magnetic field that is generated in the guide wire in this manner is then detected by two or more magnetic detection coils that have been strategically mounted on an AGV. Depending on the design of the steering system and the specific AGV application, the magnetic detection coils can be orientationally disposed in a symmetrical fashion, with both coils arranged either in a horizontal or vertical disposition. In other systems or applications, one of the two detection coils might be horizontally disposed, whereas the other might be vertically disposed. As the AGV travels along the path of the guide wire, voltages are thereby induced in the detection coils as the coils pass through the magnetic field surrounding the guide wire. Processors are used to compare the voltage induced in each detection coil so as to determine the lateral location of each coil relative to the guide wire. This information is thereinafter used to generate instructions for the drive wheels and steering mechanisms of the AGV, thus enabling the vehicle to maintain its proper or ideal course.

The wires or cables utilized in such a fixed guide wire system are generally continuous, a condition that is necessary for the wires to carry an electric current and generate the requisite magnetic field, which can then be detected by the AGV's guidance system and used to steer the vehicle. Additionally, the wires or cables are commonly mounted on or below the surface of the roadway upon which the AGV must travel, thus making the system one that is more permanent in nature, and therefore less flexible or adaptable to changing requirements. Such a system also requires the vehicles to traverse only those routes which have been pre-defined by the location of the fixed wires in the system. Such a navigation system is expensive to install, requires periodic maintenance or upkeep, and is relatively inflexible. System modifications that might be necessitated by changing applications or conveyance requirements will involve demolition and reinstallation of all or part of such a fixed wire system.

AGV navigation systems are also known which employ a grid or a line of magnets that are disposed along the roadway over which the vehicle is intended to travel. In this type of guidance system, the body of the AGV will carry a series of magnetic field sensors that are generally disposed along the longitudinal, or travel, axis of the vehicle. These magnetic field sensors are used to sense the magnets and ultimately enable the vehicle to be guided relative to the known position of the magnets. In most systems of this type, the field strengths of the magnets disposed along the vehicle's path are sensed as the magnets are traversed by the vehicle. The information gathered by the sensors is then analyzed by an on-board processing system, which subsequently provides instructions to the steering mechanism of the vehicle so that it follows the general path of the magnets aligned in the roadway as it travels from place to place within the AGV guidance system.

The magnetic sensor assemblies employed in this type of magnetic sensing system can range from a simple line of magnetic sensors disposed along the axis of the vehicle to arrays of sensors aligned in rows and columns and containing more than 250 sensing devices. When combined with the need for more complex printed circuit boards, associated signal amplifiers, and attendant microprocessing complexities, the costs associated with such large quantities of magnetic field sensors can be prohibitive.

Conversely, a simple dead-reckoning system commonly does not depend upon inputs or guidance from external sources so as to maintain a proper or ideal vehicle course. Dead-reckoning systems generally utilize sensors that are an integral part of the AGV in order to monitor the vehicle's heading, the rate-of-change of heading, and the distance traveled by the AGV, which can be controlled to match with the theoretical guide path. Dead-reckoning systems offer numerous advantages over typical fixed guide wire systems, including for example avoidance of the relatively great expense associated with installation and maintenance of guide wires in the floor along the extent of the entire guide path system. Additionally, the paths traversed by AGV's within such dead-reckoning systems are much more flexible than those of the fixed guide wire systems, as the guide paths can usually be altered or modified by implementing appropriate programming changes to the vehicular control system, rather than resorting to the time-consuming and expensive tasks of tearing up and repositioning the system's guide wires.

The typical dead-reckoning systems used in AGV's commonly rely upon a complex set of integrations to determine the exact position of the vehicle within the guide path system at any given time. The rotation angle of the wheels and the distance traveled by the AGV based upon the wheel dimensions is continuously calculated several times per second to ascertain the vehicle's theoretical position. However, numerous factors can intervene to influence the actual position of the AGV versus its calculated theoretical position, which include for example tire slippage, tire size or diameter changes caused by variations in the loads carried by the vehicle, path or roadway unevenness, speed of the vehicle, and the like. The vehicle's actual position therefore tends to drift from its theoretical position over time, and to a large or small degree depending on the confluence and relative magnitudes of the position-influencing factors noted above. As such, AGV systems that utilize dead-reckoning guidance as the primary mode of vehicular position control sometimes implement any one of a variety of location verification methods to periodically update or correct the vehicle's course. In many of these methods an apparatus is used for determining the position of the mobile vehicle relative to a fixed location marker device. Such location marker devices are commonly placed in or near the ideal path to be traveled by the AGV. Some representative types of vehicular location verification systems are briefly described below.

One type of location verification method involves the use of radio frequency identification, or RFID, tagging. In a RFID tagging system, the fixed location marker device is a transponder device that becomes energized when inductively excited by a radio wave from a transmitter that might be part of the marker locating apparatus mounted on a moving AGV. In response to such an interrogating signal, the fixed marker transponder will broadcast a return or response signal that is then detected by the locating apparatus mounted on the AGV and subsequently processed in accordance with some pre-programmed instructions to pinpoint the vehicle's position relative to the transponder. Such RFID devices can be designed to broadcast a unique identification signal, which can in turn be used together with a system of commonly designed transponders to facilitate the location, tracking, or guidance of a vehicle within the bounds of the system.

Another example of an AGV location verification method is one wherein the fixed marker is a magnet positioned in the floor at a pre-determined location along the path traversed by the vehicle. In conjunction with this system, a sensor assembly is mounted on the bottom of the AGV, comprised of an array of magnetic sensors, such as Hall-effect sensors, laterally spaced along the longitudinal, or traveling, axis of the vehicle. When the vehicle's magnetic sensor array passes over a magnet located in the floor, a sequence of outputs from the sensors are sent to and received by a processor mounted on the vehicle. The processor in turn analyzes the data supplied by the magnetic sensor array, updates the AGV's position relative to the magnet, and thereafter corrects the vehicle's course so as to maintain its proper heading and position within the guide path system.

As can be seen from the forgoing discussion, each example of a vehicular guidance or guidance-correction systems that is presented above can be used to facilitate the orderly travel and distribution of AGV's within an overall system or framework of moving vehicles, and each of which systems is possessed of its own relative strengths and weaknesses. The weaknesses inherent in these systems can sometimes be overcome to a greater or lesser degree, but usually at the expense of increased complexity, greater cost, or loss of system flexibility.

The present disclosure is directed to various methods and devices that may avoid, or at least reduce, the effects of one or more of the problems identified above.

### SUMMARY OF THE INVENTION

The following simplified summary is presented in order to provide a basic understanding of some aspects of the present subject matter. It is not an exhaustive overview, nor is it intended to identify all of the key or critical elements of the invention or to delineate the scope of the invention. Its sole purpose is to present some concepts in a simplified form as a preface to the more detailed description that is discussed later.

Generally, the present subject matter provides a means for passively detecting the distance and position of a DC field magnet based upon a two-dimensional assessment of the magnet's field strength as determined by a plurality of directionally disposed magnetic field sensors. In one illustrative embodiment, a device is disclosed that comprises two pairs of orthogonally disposed magnetic field sensors that are mounted on a printed circuit board which forms an integral part of the magnet position locator device. These magnetic field sensors continuously gather sensing information on the magnetic field strength of the DC field target magnet and transmit that sensing information to a processor positioned on the printed circuit board. The field strength information received by the processor is then analyzed using a specially-derived calculation algorithm which thereby provides specific information to the magnet position locator regarding the distance and position of the target magnet.

In a further illustrative embodiment of the magnet position locator, a device is disclosed wherein three or more single-axis magnetic field sensors are employed. The magnetic field sensors are disposed on the printed circuit board in a predetermined pattern so as to gather sensing information on the magnetic field strength of a DC field target magnet and transmit that sensing information to a processor positioned on the printed circuit board. The field strength information received by the processor is then analyzed using a specially-derived calculation algorithm which thereby provides specific information to the magnet position locator regarding the distance and position of the target magnet.

In another illustrative embodiment, the magnet position locator devices described above can be used in conjunction with a conventional automated guided vehicle system designed to operate primarily on dead-reckoning guidance. In this embodiment, the magnet position locator is mounted on board an AGV programmed to traverse a known course using dead-reckoning techniques previously described. The locator can thereafter be employed as part of a vehicular position verification system wherein the DC field target magnet operates as a fixed location marker, several of which are intermittently disposed within such a system at pre-determined sites, and the magnet position locator operates to determine the precise location of the AGV relative those strategically located and spaced target magnets. The magnet position locator thereafter provides navigational corrections to the vehicle's steering mechanism as might be required to maintain the vehicle's heading and position along the theoretical and proper course.

In yet another illustrative embodiment, the magnetic position locator device is located on or near a lifting mechanism of a vehicle designed for lifting and moving loads within an industrial or manufacturing environment. In this embodiment, the DC field target magnet is mounted or positioned within a storage system comprised of shelves, racks, bins, and the like, and which is designed for storing materials, components, or products for a period of time. As the vehicle comprised of a lifting mechanism approaches the storage system containing the target magnet, the magnetic field sensors of the magnet position locator are used to detect the distance and position of the target magnet and thereby guide the vehicle to the proper location and position for performing some appropriate loading or unloading activities. Additionally, in another embodiment, a DC field target magnet might be attached to or included with the particular material, component, or product itself that is subject to the loading or unloading activity performed by the vehicle as part of an overall material handling program. In this embodiment, the target magnet would become an integral part of the material to be handled, thereby ensuring that a target magnet is always properly located with respect to the material so as to support the need for any future handling activities.

### BRIEF DESCRIPTION OF THE DRAWINGS

The present subject matter may be understood by reference to the following description taken in conjunction with the accompanying drawings, in which like reference numerals identify like elements, and in which:

FIGS. 1A-1B depict a cylindrically shaped (rod) magnet, schematically illustrating the magnetic field patterns emitted thereby;

FIGS. 2A and 2B depict the general geometric relationship between the magnetic field sensors and the target magnet;

FIG. 3A depicts an illustrative embodiment that includes a schematic plan view of the magnet position locator, including a printed circuit board (PCB) with two dual-axis magnetic field sensors;

FIGS. 3B-3D depict various embodiments of the magnet position locator of FIG. 3A, wherein a variety of magnetic field sensors types and sensing orientations are employed;

FIG. 3E depicts an illustrative embodiment of the magnet position locator device that employs three single-axis magnetic field sensors;

FIG. 4 depicts the two orthogonal magnetic field sensors of FIG. 3A and a target magnet, schematically illustrating the sensing directions and relative positions of the two sensors with respect to the angular directions of the sensors to the target magnet;

FIG. 5 depicts the orthogonal magnetic field sensors and target magnet of FIG. 4, further illustrating a common coordinate system used for determining the location of the target magnet relative to the sensors;

FIGS. 6A-6C depict an illustrative embodiment that includes the magnet position locator device mounted on a driverless vehicle, such as an AGV, and a schematic representation of a theoretical or ideal path that might be traveled by such a vehicle; and

FIGS. 7A-7B depict another illustrative embodiment that includes the magnet position locator device mounted on an AGV that is designed for locating and lifting objects from a storage rack.

While the subject matter disclosed herein is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE INVENTION

Illustrative embodiments of the disclosed subject matter are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nonetheless be a routine undertaking for those of ordinary skill in the art having the benefit of this disclosure.

The present subject matter will now be described with reference to the attached figures. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

The subject matter described below can be distinguished from many prior art devices in that these embodiments describe “passive” position detection devices, whereas many of the prior art devices might be considered as “active” position detection devices. Consider, as one example of an “active” detection device, an automated guided vehicle system employing radio frequency identification tagging as the primary means for providing navigational corrections to an AGV, as previously described. In an RFID system, the RF tag markers respond to an electrical excitation by returning a signal with the tag's identification number to the AGV's navigational system, which in turn determines the location of that specific RF tag by accessing a database of information containing the positions of all RF tags within the AGV system, based upon tag ID number. The device is therefore “active” due to the acts of electrically exciting the RF tag makers and in returning an identifying signal. The embodiments described below, however, utilize directional magnetic field sensing devices to “passively” monitor the strength of a DC magnetic field—which, unlike the RF tag signal, does not inherently carry any data. The peak strength of the magnetic field is then utilized to pinpoint the location of the magnet by providing a two-dimensional measurement of the magnet's position with respect to the positions of the magnetic field sensors.

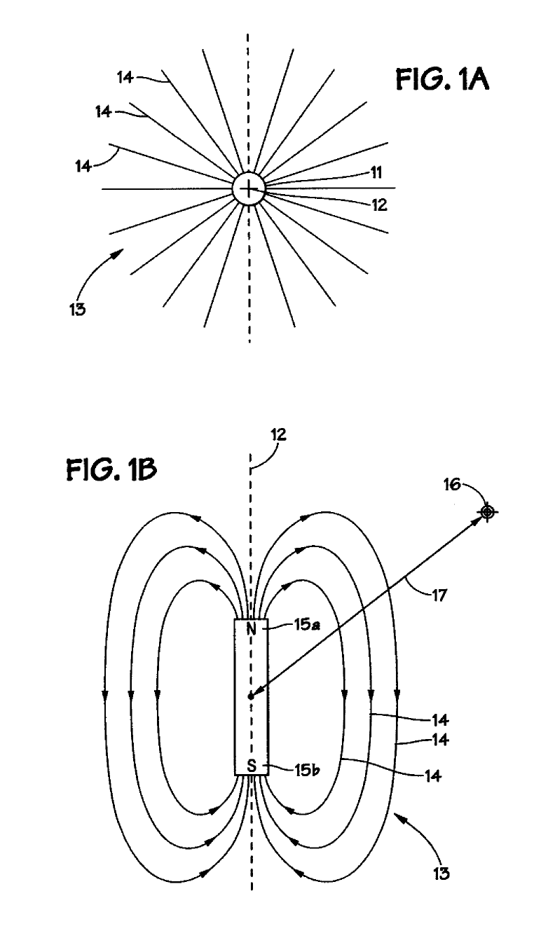

FIG. 1A shows a DC magnet 11 of circular cross-section, also know to one skilled in the art as a rod magnet, having a longitudinal axis 12 extending perpendicular to the plane of view. The DC rod magnet 11 emits a magnetic field 13 characterized by lines of magnetic flux 14 extending radially outwardly from the axis 12 of the rod magnet 11.

FIG. 1B is a side view that further illustrates the pattern formed by the magnetic field 13, showing the lines of magnetic flux 14 extending outwardly from each of the poles 15a, 15b of the rod magnet 11. Although it is well recognized by those skilled in the art that there is no actual physical “flow” of the magnetic field—as might otherwise be implied by a directional description—it is nonetheless convenient to describe the lines of magnetic flux 14 as emanating from the north pole 15a in a direction that is initially tangential to the longitudinal axis 12, thereafter extending arcuately around the magnet 11 and returning to south pole 15b tangentially to the axis 12.

In FIGS. 1A and 1B, the magnetic field 13 of the rod magnet 11 is illustrated using only a few lines of magnetic flux 14 for purposes of illustrative clarity. In actuality these lines of flux 14 are infinite in number and when viewed from above and along the longitudinal axis 12 of the magnet 11, as in FIG. 1A, form a magnetic field that extends radially, as the spokes of a wheel. Likewise, when viewed from almost any other angle, such as in FIG. 1B, the lines of flux 14 of the radiated magnetic field 13 of a rod magnet 11 would appear to have the general shape of an infinite number of donuts placed around the axis 12 of the rod magnet 11, each of an indefinite size and a center of zero diameter. As would be well understood by one skilled in the art, it should be further noted that the strength of the magnetic field 13 as measured from a randomly located point 16 will be directly proportional to the actual strength of the magnet and inversely proportional to a function of its distance 17 from the magnet 11. For example, for a cylindrically shaped rod magnet of length L, radius R, and a surface magnetic flux density Br, the magnetic field strength as measure at a distance D from the center of the magnet would be described by the following equation.

$$Field\_Strength = \frac{Br}{2} \times \{ [ \frac{L + D}{\sqrt{{( L + D )}^{2} + {R}^{2}}} ] - [ \frac{D}{\sqrt{{( L + D )}^{2}}} ] \}$$

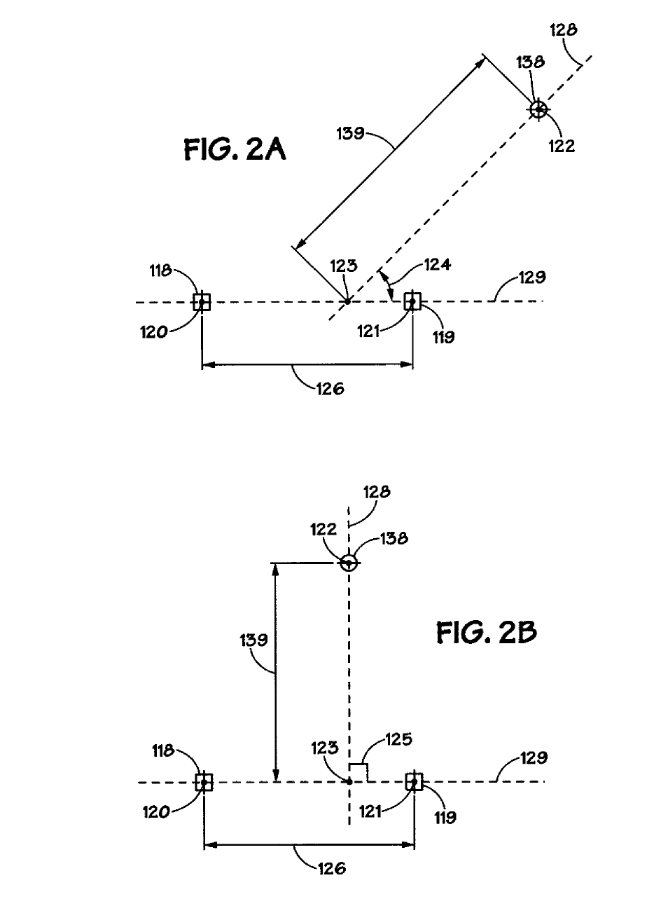

In FIGS. 2A and 2B, the general geometric arrangement of a magnet 138 relative to two magnetic field sensors 118 and 119 is schematically illustrated. FIG. 2A depicts the magnet 138 having a center point 122 that is located on an axis 128. Magnetic field sensors 118 and 119 are located at points 120 and 121 respectively and spaced apart by a distance 126. Both magnetic field sensors 118 and 119 are further located on a mounting axis 129 defined by a line passing through points 120 and 121. Axis 128 projecting through the center point 122 of magnet 138 intersects the mounting axis 129 at a point 123 that is positioned between the two magnetic field sensors 118 and 119. Magnet 138 is separated from intersecting point 123 on mounting axis 129 by a distance 139.

As illustrated in FIG. 2A, in one illustrative embodiment of the disclosed subject matter, the mounting axis 129 is substantially transverse to the magnet center point axis 128, i.e., the angle of intersection 124 between axes 129 and 128 is a positive angle greater than zero. FIG. 2B illustrates yet another embodiment of the disclosed subject matter wherein axis 128 and the mounting axis 129 are orthogonal, or mutually perpendicular. Stated in another way, in the embodiment illustrated by FIG. 2B axis 128 intersects mounting axis 129 at a 90° angle, i.e., at a right angle.

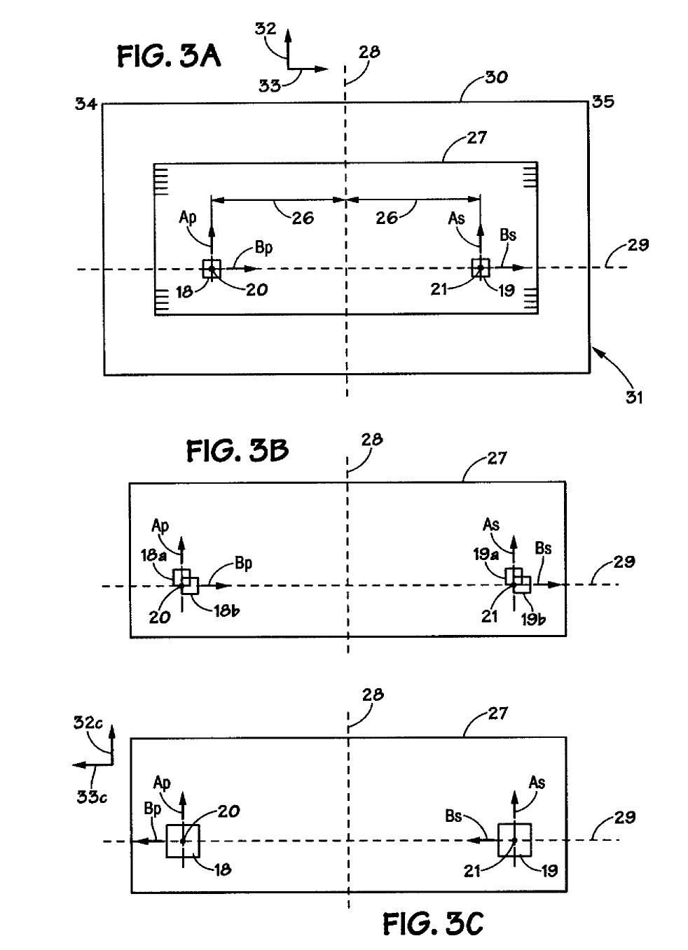

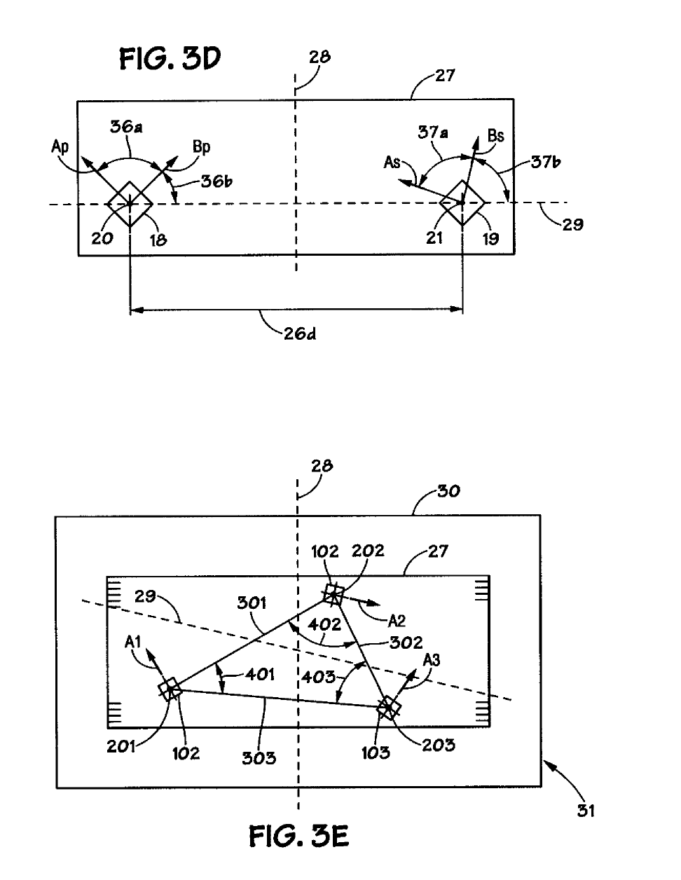

One illustrative embodiment of the magnet position locator 31 described herein is schematically illustrated in FIG. 3A. For illustrative purposes, the directional orientation of the magnet position locator 31 will be defined with respect to a reference line 28, to sides 34 and 35, and to relative directions 32 and 33. Direction 32 is defined as the “forward” direction of the magnet position locator 31, and is oriented parallel to reference line 28. Port side 34 is defined as the left side of the magnet position locator 31 when facing in the forward direction 32, i.e., to the left of reference line 28, and starboard side 35 is defined as the right side when facing in the forward direction 32, i.e., to the right of reference line 28. Direction 33 is defined as the “starboard” direction of the magnet position locator 31, and is oriented orthogonally to direction 32 and perpendicular to reference line 28.

In this illustrative embodiment, two dual-axis magnetic field sensors 18, 19 are mounted on a printed circuit board (PCB) 27. For descriptive clarity, it should be noted that typically a dual-axis magnetic field sensor is a single device comprised of two distinct and axially oriented magnetic field sensors. One of the magnetic sensors of the dual-axis pair can be said to detect a magnetic field that is located in the “A” sensing direction of the dual-axis device, and the other magnetic sensor of the dual-axis pair can be said to detect a magnetic field that is located in the “B” sensing direction of the dual-axis device. In some embodiments, sensing direction “B” may be oriented in an orthogonal manner to sensing direction “A”.

Further describing the present embodiment, dual-axis magnetic field sensor 18 is mounted at a center point 20 that is positioned on a mounting axis 29 a known distance 26 on the port side 34 of reference line 28. Similarly, dual-axis magnetic field sensor 19 is mounted at a point 21 that is also positioned on mounting axis 29 at the same known distance 26 on the starboard side 35 of reference line 28. Both magnetic field sensors 18 and 19 are mounted on PCB 27 in such a manner that the “A” sensing direction of each magnetic field sensor is oriented and aligned with forward direction 32, i.e., parallel to reference line 28. Magnetic field sensors 18 and 19 are further mounted on PCB 27 such that the “B” sensing direction of each is oriented and aligned with starboard direction 33, i.e., perpendicular to reference line 28 and parallel to mounting axis 29. PCB 27 is further mounted inside a non-magnetic enclosure 30 of magnetic position location 31.

Another embodiment is partially depicted in FIG. 3B, wherein two pairs of single-axis magnetic field sensors 18a, 18b and 19a, 19b are mounted on PCB 27 in lieu of dual-axis magnetic field sensors 18, 19. In this embodiment, each pair of single-axis magnetic field sensors 18a, 18b and 19a, 19b are mounted with orthogonally oriented sensing directions, and may be located very close to each other so as to approximate the functionality of the dual-axis magnetic field sensors 18, 19 and to facilitate the target magnet location operation further described in the discussion of FIG. 5. For example, single-axis magnetic field sensors 18a and 18b are located a known distance 26 to the port side 34 of reference line 28, and as close as practicable to each other on PCB 27. Similarly, single-axis magnetic field sensors 19a and 19b are located a known distance 26 to the starboard side 35 of reference line 28 and as close as practicable to each other. Magnetic field sensors 18a and 19a are mounted on PCB 27 in such a way that the magnetic field sensing direction of each—i.e., the “A” sensing direction—is oriented and aligned with the forward direction 32 and parallel to reference line 28. Additionally, magnetic field sensors 18b and 19b are mounted on PCB 27 such that that the sensing direction of each—i.e., the “B” sensing direction—is oriented and aligned with the starboard direction 33, perpendicular to reference line 28 and parallel to mounting axis 29.

For descriptive simplicity in the following disclosure, it is presumed that the dual-axis magnetic field sensors 18 and 19 are functionally indistinguishable from the pairs of single-axis magnetic field sensors 18a, 18b and 19a, 19b when mounted on PCB 27 in the manner described for FIGS. 3A and 3B above. Consequently and unless specifically noted otherwise, all subsequent references to either a magnetic field sensor or an orthogonal magnetic field sensor shall interchangeably be taken to mean either a dual-axis magnetic field sensor as described for FIG. 3A above, or a pair of single-axis magnetic field sensors as described for FIG. 3B.

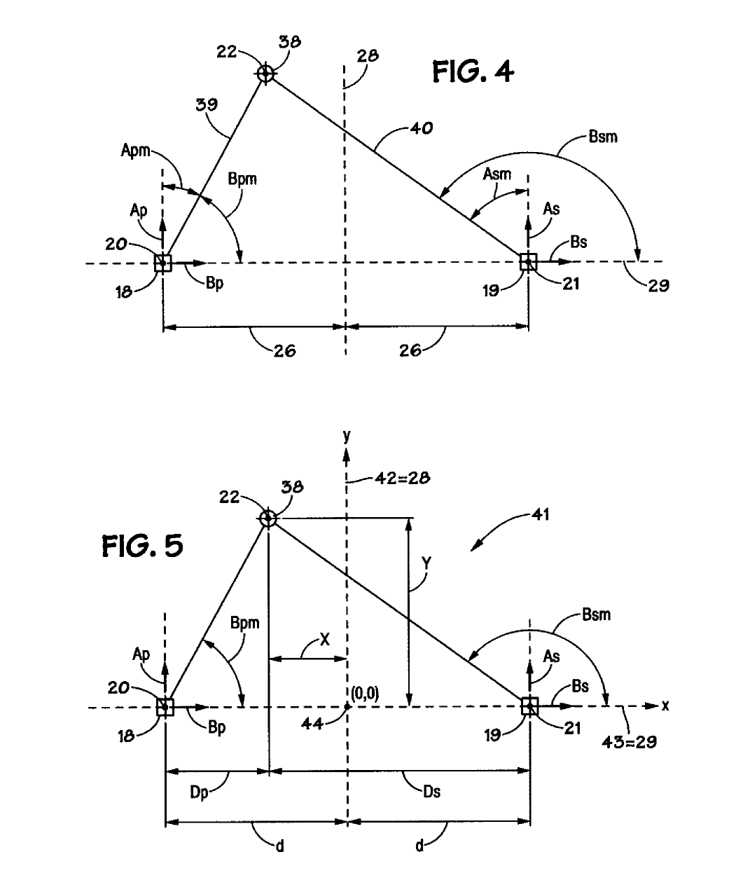

As will be appreciated by one of ordinary skill in the art after a complete reading of the present application, directionally sensing the magnetic field of a magnet utilizing a configuration, orientation, or quantity of magnetic field sensors other than those disclosed in FIGS. 3A and 3B above may facilitate determining the distance and position of a magnet for some specialized types of applications. In such cases, when the sensing directions are either not orthogonal, or are not aligned or associated with a typical right-hand coordinate system, the skilled practitioner would as a matter of course need to derive and/or modify the geometric and/or trigonometric relationships that are outlined in the discussion of FIGS. 4 and 5 below, and which are necessary to determine the magnet's position. FIG. 3C partially illustrates one such embodiment. In this illustrative embodiment, relative direction 32c is the same as direction 32 depicted in FIG. 3A and as described above, i.e., direction 32c is the “forward” direction of the magnet position locator 31 and is oriented parallel to reference line 28. Relative direction 33c is oriented in an opposite sense to direction 33 of FIG. 3A, i.e., direction 33 is the “port” direction of the magnet position locator 31, and is oriented orthogonally to direction 32 and perpendicular to reference line 28. The “B” sensing directions of magnetic field sensors 18 and 19 in this embodiment are oriented and aligned with the port direction 33c, perpendicular to reference line 28 and parallel to mounting axis 29.

FIG. 3D depicts another such illustrative embodiment, wherein magnetic field sensors 18 and 19 are disposed on a mounting axis 29 and spaced apart by a known distance 26d. However, unlike the previous embodiments disclosed in FIGS. 3A-3C and discussed above, the “A” and “B” sensing directions of magnetic field sensors 18 and 19 in the depicted embodiment are not oriented or aligned with either the reference line 28 or the mounting axis 29. In this illustrative embodiment, the “Bp” sensing direction of magnetic field sensor 18 is oriented at an angle 36b from mounting axis 29, and the “Ap” sensing direction is further oriented at an angle 36a from the “Bp” sensing direction. In a similar fashion, the “Bs” sensing direction of magnetic field sensor 19 is oriented at an angle 37b from mounting axis 29, and the “As” sensing direction is oriented at an angle 37a from the “Bs” sensing direction.

FIG. 3E shows yet another illustrative embodiment, wherein a plurality of single-axis magnetic field sensors 101, 102 and 103 are disposed at mounting points 201, 202 and 203 respectively. In an illustrative embodiment, the location of each mounting point is selected so as to lie in the common plane of the printed circuit board 27. Accordingly, the distances 301, 302, 303 and angular relationships 401, 402, 403 between the mounting points are readily known. Further describing this illustrative embodiment, mounting axis 29 is located in the same plane as mounting points 201, 202, and 203, and is also oriented substantially transverse to the magnet position locator reference line 28. The sensing directions A1, A2, and A3 that are associated with magnetic field sensors 101, 102, and 103 respectively can be aligned in any suitable direction, for example, in a direction that would be most advantageous for facilitating magnetic field sensing and subsequent determination of a target magnet's position relative to the sensors. As can further be realized from the foregoing description of FIG. 3E, the present embodiment can easily be modified to include additional magnetic field sensors, such as sensor 104, 105, etc., located at mounting points 204, 205, etc., each of which may also be mounted in the common plane of the PCB 27. The quantity of sensors actually employed and the final disposition of those sensors on the printed circuit board 27 would ultimately be determined based on the specific application to which the magnetic position locator 31 might be adapted.

As previously noted, modifications might be required to the equations (described below) used for determining the position of a magnet when utilizing the magnetic field sensing approaches disclosed in the embodiments illustrated by FIGS. 3C, 3D, 3E, or other geometric variations. Provided the requisite sensor spacing and relative sensing orientation information is known, such modifications are believed to be within the level of ordinary skill in the art having the benefit of the present disclosure. However, for descriptive simplicity, the following disclosure addressing the geometry of the magnet position locator and subsequent algorithm derivation will address only those embodiments illustrated in FIGS. 3A and 3B, i.e., orthogonally disposed pairs of magnetic field sensors.

FIG. 4 schematically depicts the positions of the two orthogonal magnetic field sensors 18 and 19 of FIG. 3A relative to the position of a target magnet 38, whose location will be determined as described in the discussion of FIG. 5. The target magnet 38 can be any permanent DC magnet whose magnetic field is of a minimum strength that would be detectable by the magnetic field sensors. As will be appreciated by a practitioner of ordinary skill in the art and having the benefit of the present disclosure, the size and shape of the permanent DC target magnet might vary over a relatively wide range without unduly affecting the operation of magnet position locator. By way of example, the target magnet might take a generally circular cross section, wherein the overall shape of the magnet is that of a disc, a donut, a ring, a tube, or a cylinder. Use of a magnet with a circular cross-section might be advantageous in the described embodiment because the lines of magnetic flux are relatively symmetrical and constant with respect to the longitudinal axis of the magnet. Even so, the target magnet might also have a non-circular cross section, such as that of a square or rectangle, provided however that the square or rectangular cross dimensions of the magnet are made to be relatively small when compared to the sensing distances involved.

It should be further noted that the strength of the Earth's local magnetic field can influence the field strength readings as detected by the magnetic field sensors. Consequently, the minimum strength of the target magnet may need to be at least greater than and distinguishable from that of the Earth's local magnetic field. Alternatively, the Earth's local magnetic field would have to be calibrated out of the readings. If the Earth's field strength is calibrated out, the field strength required to facilitate a proper reading by the magnetic field sensors may be much smaller than that of the Earth's local magnetic field. In this case, and depending on the operating parameters of a given specific application, the target magnet could have a magnetic field strength (or magnetic flux density) at its surface in the range of approximately of 5000-15,000 gauss. In one illustrative embodiment, the target magnet 38 would be, for example, a cylindrically shaped rod magnet with a minimum magnetic field strength at its surface of approximately 8000 gauss.

The sensing magnitude associated with the orthogonal sensing directions for each of the magnetic field sensors 18, 19 shown in FIG. 4 can be used to define an orthogonal vector pair centered at each sensor. The vector pair Ap, Bp centered at magnetic field sensor 18 on port side 34 of the magnet position locator 31 represents the magnetic field strength of target magnet 38 as seen by sensor 18. Similarly, the orthogonal vector pair As, Bs centered at magnetic field sensor 19 represent the magnetic field strength of target magnet 38 as seen by sensor 19 on starboard side 35 of the magnet position locator 31.

For the embodiments illustrated in FIGS. 4-7A, the target magnet 38 is typically located at a point that is in the forward direction 32 of, i.e., in front of, the magnet position locator 31. Notwithstanding these illustrations, the embodiments described herein can also be utilized to determine the position of a magnet that is disposed behind the magnet position locator 31, i.e., in a direction that is opposite of the forward direction 32. The right hand coordinate system and position location formulae described in conjunction with FIG. 5 below can readily be adapted to accommodate such an alternative configuration. However, considering that a great many of the applications associated with the presently disclosed subject matter involve guidance of AGV's that are traveling primarily in a “forward” direction, the disclosure following hereinafter has been simplified to address those embodiments wherein the target magnet is disposed in the forward direction 32 of the magnet position locator 31. Accordingly, it should be understood that the present invention is not limited to situations where the target magnet is disposed in the forward direction 32 of the magnet position locator 31.

Returning to the subject matter illustrated in FIG. 4, a line 39 can be defined between the center point 20 of the port side orthogonal magnetic field sensor 18 and the longitudinal axis or centerline 22 of the target magnet 38. Similarly, a line 40 can be defined between the center point 21 of the starboard side orthogonal magnetic field sensor 19 and the centerline 22 of the target magnet 38. Angular relationships can also be defined between lines 39 and 40 and the vectors which correspond to the “A” and “B” sensing directions of each orthogonal magnetic field sensor. As illustrated in FIG. 4, “Apm” corresponds to the angular dimension between vector Ap and line 39 between the centers of sensor 18 and magnet 38. Angle “Bpm” defines the corresponding angle between vector Bp and line 39. Similarly, “Asm” and “Bsm” define the angles between vectors As and Bs respectively, and line 40 between the centers of sensor 19 and magnet 38.

FIG. 5 illustrates a common coordinate system 41 that can be used for determining the location of the target magnet 38 with respect to the known relative locations of the magnetic field sensors 18 and 19. To facilitate this approach, a right-handed Cartesian coordinate system 41 employing x- and y-axes is utilized. As shown in FIG. 5, the x-axis 43 of the coordinate system 41 is defined as the line including both center points 20 and 21 of the two orthogonal magnetic field sensors 18 and 19, respectively, and is therefore coincident with mounting axis 29 as shown in FIG. 3A. The positive direction of the x-axis 43 is oriented in the starboard direction 33 of the magnet position locator 31, also as shown in FIG. 3A. The y-axis 42 of the coordinate system is defined as a line that is perpendicular to the previously defined x-axis 43 and equally spaced between the center points 20 and 21 of sensors 18 and 19. The y-axis 42 is therefore coincident with reference line 28 of the magnet position locator 31, as shown in FIG. 3A. As is the case for any Cartesian coordinate system, the location of the system origin 44, or (0,0) point, is at the intersection of the x-axis 43 and y-axis 42. This point is located midway between center points 20 and 21.

The distinct advantages of selecting the coordinate system 41 to align and/or coincide with these known locations within the magnet position locator 31 can readily be seen. The x-axis 43 coincides with the “B” sensing direction vectors of both magnetic field sensors 18 and 19, vectors Bp and Bs respectively. Furthermore, the “A” sensing direction vectors of sensors 18 and 19 are each perpendicular to x-axis 43 and parallel to the y-axis 42 of the system. In keeping with the well-known conventions of such a right-handed coordinate system, all positive angles are defined as rotating counter-clockwise from the x-axis 43, i.e., the vectors Bp and Bs.

Additionally, it should be understood that coordinate system 41 of FIG. 5 as defined above can now be used to develop an algorithm solution or calculation approach for locating the target magnet 38. It is clearly understood that the magnitude of the magnetic field as seen by any field sensor will vary by some inverse function of the sensor's distance from a magnet and by some proportional function to the magnet's actual surface field strength. For purposes of developing this algorithm, it will be assumed that any one of the four magnetic field sensors (dual sensors 18 and 19, or single-axis sensor 18a, 18b, 19a and 19b) of the present magnet position locator device 31 will provide substantially similar magnitude results as compared to the other three sensors, when those sensors are exposed to the same magnetic field and to the same magnet position and distance offset conditions. Further, the orthogonal vector pair Ap and Bp, representing the forward and starboard field strength vectors respectively at the center point 20 of magnetic field sensor 18, are located a distance “d” to the port side 34 of reference line 28 of the magnet position locator 31; additionally, the orthogonal vector pair As and Bs, representing the forward and starboard field strength vectors respectively at the center point 21 of magnetic field sensor 19, are similarly located a distance “d” to the starboard side 35 of reference line 28 of the magnet position locator 31.

As noted previously, the magnitude of a sensed magnetic field will vary according to the distance between the magnet and the magnetic field sensor. Most importantly for purposes of developing an algorithm based on the coordinate system 41 of FIG. 5 and the relative positions of the target magnet 38 and the magnetic field sensors 18 and 19, the magnitude as measured by each sensor will also vary according to the cosine of the angle between the sensor's sensing direction and the target magnet 38. From these relative angles, as illustrated in FIG. 4 and described above, and from information which can be readily obtained by those skilled in the art, the following relationships can be developed:

Ap=k×cos(Apm)

Bp=k×cos(Bpm)

As=k×cos(Asm)

Bs=k×cos(Bsm)
where the value “k” represents the total signal strength of the magnetic field 13 of the target magnet 38 as measured at each of the magnetic field sensors 18 (for vectors Ap, Bp) and 19 (for vectors As, Bs). In actuality, the value “k” will be a direct function of the target magnet's field strength and an inverse function of the distance and position between the target and the sensor, i.e.:

k=f (field strength; distance; position)

For purposes of further algorithm development, it is assumed that the pair of sensors comprising any orthogonal magnetic field sensor share a common mounting center point, i.e., the two sensors are very small relative to their distance from a target magnet, and that the distance and position of each sensor to the target magnet are equal. When considering the ninety degree directional sensing offset of each sensor pair which comprise each orthogonal sensor 18 and 19, the following field strength vector relationships can be developed:

Ap=k×sin(Bpm)

Bp=k×cos(Bpm)

and:

As=k×sin(Bsm)

Bs=k×cos(Bsm)
The ratio of the magnetic field signals from the two sets of field strength vectors Ap, Bp and As, Bs can now be simplified as follows:

$$\frac{Ap}{Bp} = \frac{k \times sin ( Bpm )}{k \times cos ( Bpm )} = \frac{sin ( Bpm )}{cos ( Bpm )} = tan ( Bpm )$$

and:

$$\frac{As}{Bs} = \frac{k \times sin ( Bsm )}{k \times cos ( Bsm )} = \frac{sin ( Bsm )}{cos ( Bsm )} = tan ( Bsm )$$

From the trigonometric equations illustrated above, the ratio of Ap/Bp for the magnetic field signals measured at orthogonal sensor 18 provides the tangent of the angle between the sensor center point 20 and the target magnet 38. Similarly, the ratio of As/Bs for the signals measured at sensor 19 provides the tangent of the angle between sensor center point 21 and the target magnet 38. With these two angles and the distance separating the center points 20 and 21 known, the specific location of the target magnet 38 can now be readily determined by solving for the X and Y coordinates of the target magnet as illustrated in FIG. 5. From FIG. 5 and the various angular and dimensional parameters outlined above, the positive Y-offset of the target magnet 38 within the frame of reference of the magnet position locator 31 is determined as follows:

$$tan ( Bpm ) = \frac{Ap}{Bp} = \frac{Y}{Dp} ; or Dp = Y \times ( \frac{Bp}{Ap} )$$

and:

$$tan ( Bsm ) = \frac{As}{- Bs} = \frac{Y}{Ds} ; or Ds = Y \times ( \frac{- Bs}{As} )$$

and since:

Dp+Ds=2×d
then the Y-offset can be determined in terms of the known spacing between the two sensor center points 20 and 21, as follows:

$$Dp + Ds = Y \times ( \frac{Bp}{Ap} + \frac{- Bs}{As} ) 2 \times d ;$$

or:

$$Y = \frac{2 \times d}{( \frac{Bp}{Ap} - \frac{Bs}{As} )}$$

as stated in terms of the known value “d”, and the known magnetic field signal strength vector pairs Ap, Bp and As, Bs, as measured at magnetic field sensors 18 and 19, respectively.

From a value of Y as thus determined, the X-offset value can be readily obtained by either of the following two equations:

$$X = Dp - d = \frac{Y}{tan ( Bpm )} - d = \frac{Y}{( \frac{Ap}{Bp} )} - d = Y \times ( \frac{Bp}{Ap} ) - d$$

and:

$$\begin{matrix}X = d - Ds \\ = d - \frac{Y}{tan ( Bsm )} \\ = d - \frac{Y}{( \frac{As}{- Bs} )} \\ = d - Y \times ( \frac{- Bs}{As} ) \\ = d + Y \times ( \frac{Bs}{As} )\end{matrix}$$

each of which are stated in terms of the known values “d” and Y. It should be additionally noted that the above two solutions for the value X can be combined to eliminate the known value “d”, therefore solving for X in terms of Y only, as follows:

$$X + X = Y \times ( \frac{Bp}{Ap} ) - d + d + Y \times ( \frac{Bs}{As} ) = Y \times ( \frac{Bp}{Ap} + \frac{Bs}{As} )$$

or:

$$X = ( \frac{Y}{2} ) \times ( \frac{Bp}{Ap} + \frac{Bs}{As} )$$

The mathematical calculations outlined in the development of the suggested algorithm above can be programmed to be performed by a computing device such as a computer or other type of microprocessor or logic device. Printed circuit board 27 can be designed and arranged so as to process and transmit the magnetic field signal strength information obtained by magnetic field sensors 18 and 19 to such a computing device, whereupon the position of magnet 38 can be ascertained. The position of magnet 38 can thereinafter be used to facilitate other functions and applications of the presently disclosed subject matter, as outlined in the illustrative embodiments discussed below.

It should once again be noted that development of the aforementioned suggested algorithm is based upon utilizing a typical right-hand Cartesian coordinate system. When considering magnetic field sensing directions which do not precisely align with a typical right-hand system, such as are depicted in FIGS. 3C and 3D, a similar approach to algorithm development may be necessary so as to derive the appropriate magnet position calculations. However, such an undertaking is believed to be within the level of skill in the art and having benefit of the present disclosure. Consequently such particulars are not discussed in any further detail in the current disclosure.

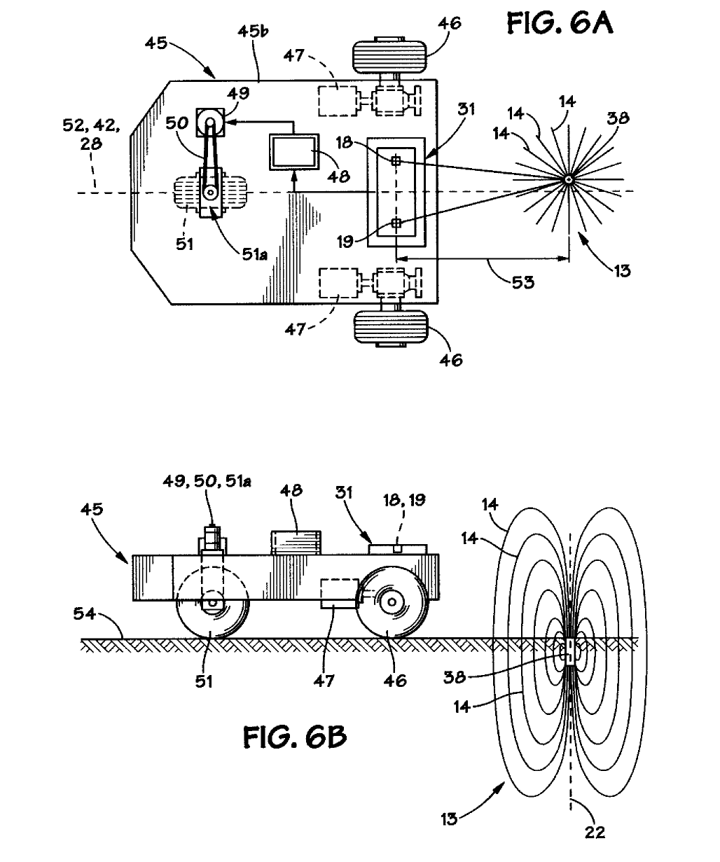

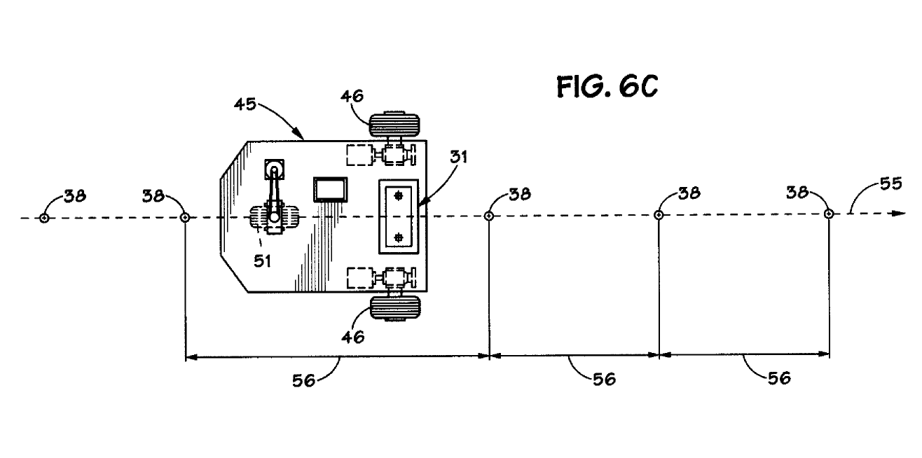

FIGS. 6A and 6B schematically illustrate an embodiment wherein the magnet position locator 31 is used in conjunction with an automated guided vehicle system so as to maintain the proper heading and position of an automated guided vehicle (AGV) while that vehicle is traveling within the AGV system. Typically, an AGV system includes one or more vehicles traveling over a pre-determined pathway while performing a set of pre-determined activities. FIG. 6A schematically illustrates a plan view of one such type of AGV 45 that might be used in an AGV system. It should be noted that the configuration of the AGV 45 illustrated by FIG. 6A is exemplary only. The size and configuration of AGV's in general may vary from system to system and from application to application depending on many factors, some of which factors might include the specific activity to be performed by the AGV, the size of the load to be carried, the speed at which the AGV must travel, the complexity of the pathway upon which it must travel, and the total number of AGV's utilizing the system at any given time. However, even considering these varying and competing factors, most AGV's will have certain characteristics in common. By way of example, some of those common characteristics may include a body whose weight and/or load is supported by a plurality of wheels, wherein one or more of those wheels are adapted for driving the vehicle and one or more are adapted for steering the vehicle. The methods employed for powering the driving wheels of the vehicle may vary. Additionally, some AGV's may also include a simple or sophisticated means by which to control the steering of the vehicle so as to maintain the vehicle's intended course. The number of wheels adapted for the driving or steering functions on the AGV may vary depending on the system or application, as may the optimal locations of those function-adapted wheels, e.g., in the front or in the rear of the vehicle.

From the foregoing brief discussion, it is understood that there are a multiplicity of possible AGV designs. As such, the discussion of certain illustrative embodiments of automated guided vehicles that follows should not be interpreted to limit the applicability of the present disclosure to those illustrative embodiments discussed herein.

In the present illustrative embodiment depicted in FIG. 6A, the AGV 45 includes a body 45b, the weight of which is supported by two forward drive wheels 46 and one rear steering wheel 51. Each drive wheel 46 is driven by a device adapted to provide rotational power, such as an electric DC motor 47. In this illustrative embodiment, steering of the AGV is performed via manipulation and control of the rear steering wheel 51, which manipulation and control might be accomplished in any of one variety of methods. In one illustrative example as shown in FIG. 6A, the orientation of a steering assembly 51a might be adjustably controlled by a steering control device 49 via the rotational manipulation of a drive belt or chain 50 linking the steering control device 49 to the steering assembly 51a. Specific instructions on controlling or adjusting the orientation of steering assembly 51a might be provided to the steering control device 49 from a suitably designed and programmed computer or microprocessor 48 which receives information on the heading of AGV 45 as outlined below. As one example, such a control system for automated guided vehicles is disclosed in U.S. Pat. No. 6,345,217, which is hereby incorporated by reference in its entirety.

In this illustrative embodiment, a magnet position locator 31 is mounted on AGV 45 and detects the magnetic field 13 of a rod magnet 38, represented in FIGS. 6A and 6B by lines of magnetic flux 14 emanating radially and arcuately from the centerline 22 of the magnet 38. The rod magnet 38 is embedded in the floor or other working surface 54 of a typical working environment, such as a warehouse, factory, or similar storage, shipping, or manufacturing facility. The magnet position locator 31 utilizes the orthogonal magnetic field sensors 18 and 19 and to measure the strength of the magnetic field 13 in the forward direction 32 of the AGV 45, and determines the exact distance and position of the magnet 38 in accordance with the algorithm method outlined above in the discussion of FIGS. 4 and 5.

The AGV 45 used in this particular embodiment is of a common type that might use the dead-reckoning approach as its primary method of vehicle navigation. As noted in discussion above, the guidance of dead-reckoning AGV's is subject to some amount of accumulation of error over time, such as might be attributable to tire slip, path unevenness, variation in the speed of the vehicle, and tire diameter changes caused by load variations. When mounted on AGV 45, the magnet position locator device 31 disclosed herein may be utilized to provide minor course correction inputs to the vehicle's steering control device 49 so as to adjust the orientation of steering wheel 51 and keep AGV 45 on its pre-determined path. The frequency at which such course corrections might be necessary would be dependent on many factors, including for example all of those factors listed above which might influence the amount of error in a dead-reckoning type of vehicle, as well as the degree of accuracy that would be needed for the specific task for which AGV 45 is employed.

Once the frequency at which course corrections for the particular application must be performed has been ascertained, a plurality of target magnets 38 would be placed in the floor 54 along a theoretical or ideal guide path 55 at a common spacing 56, as schematically illustrated in FIG. 6C. When taken in combination with the nominal travel speed of AGV 45, the target magnet spacing 56 will correspond to a specific frequency at which corrections are determined by the magnet position locator 31 when the magnetic field 13 of each target magnet 38 is sensed by the magnetic field sensors 18 and 19. Depending on the application, such target magnet spacing 56 could range, for example, from 1 to 10 meters, however a typical target magnet spacing 56 that might be used in a heavy industrial or manufacturing environment would be approximately 3 to 5 meters.

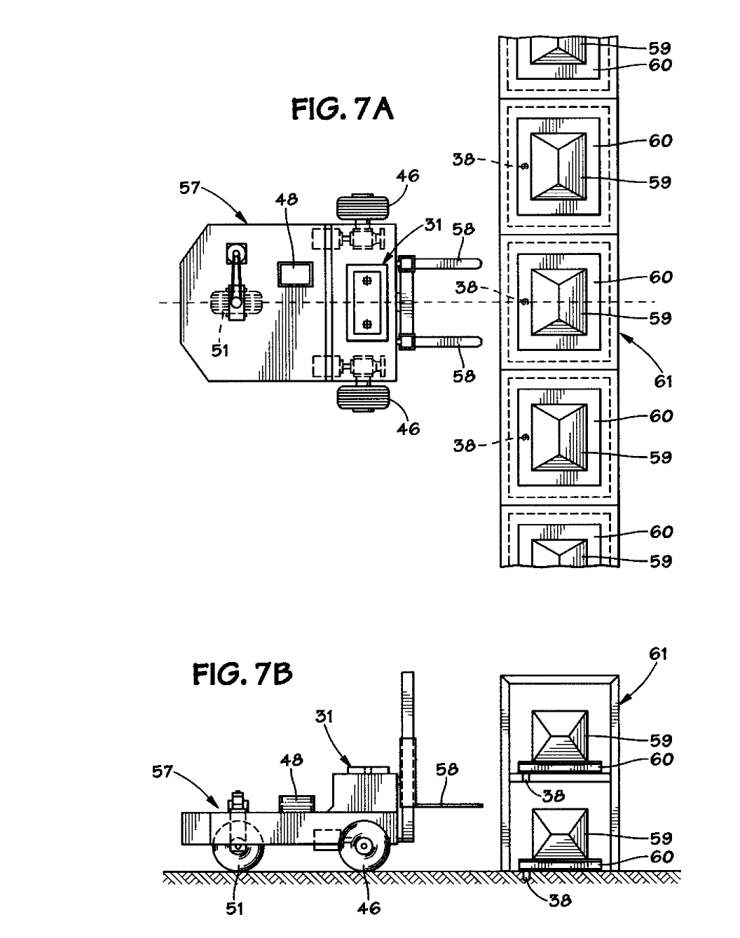

FIGS. 7A and 7B further illustrate another embodiment wherein the magnet position locator 31 is advantageously mounted on or near the lifting forks 58 of an AGV 57. The AGV 57 is specially designed for transporting objects 59 that are supported on pallets 60 to and from a storage rack 61, which is utilized for the staging of objects 59 during some particular phase of a manufacturing, packaging, storing, or shipping operation within a factory environment. Objects 59 are loaded on or unloaded from storage rack 61 by using the magnet position locator 31 to determine the position of a target magnet 38 that has been mounted in storage rack 61 in such a location as to facilitate the aforementioned loading or unloading activities. In such an embodiment, the magnetic field sensors 18 and 19 of the magnet position locator 31 would be used to sense the magnetic field 13 of the target magnet 38 and, using the algorithm procedure described above, more accurately direct the AGV 57 to the proper position for the loading or unloading operation of pallet 60 and object 59 as previously described. It should be noted that the object 59 that is transported by AGV 57 could be comprised of any one of a number of things that are commonly moved by AGV's, including by way of example raw materials, components, finished products, packages, crates, tools, waste, etc.

Another embodiment would be the device as illustrated by FIGS. 7A-7B and described above, wherein the target magnet 38 is mounted in the pallet 60. The benefits of this particular embodiment are obvious, as the target magnet 38 remains with the pallet 60 and object 59, irrespective of where they may be stored, thus avoiding the necessity of a structured and space-limiting system of storage racks 61.

Some practical design considerations of the magnet position locator 31 will now be highlighted for those skilled in the art of magnetic field sensing and magnet position locating. It is noted that the calculated values of Y using the equations above will be valid and positive for all positive values of both Ap and As, that is, as long as the target magnet 38 remains in the forward direction 32 of the two magnetic field sensors 18 and 19. As a practical matter, and except for a noisy set of magnetic field signals, the sensors 18 and 19 would be designed such that the divisor of the equation solving for the value Y above is not permitted to go to zero, that is Bp/Ap cannot become equal to Bs/As in a properly designed and operating magnet position locator 31. Additionally, in order to provide maximum linearity, with most practical signal-to-noise ratios, any magnet position calculation should be terminated and discarded if the values measured for As and Ap approach that of zero. For example, in a typical and representative magnet position locator design, the readings would be discarded as too noisy if Y is calculated at a relatively small value with respect to the known distance between the magnetic field sensors 18 and 19, such as one that is less than a value of approximately d/8.

In some examples, the type of magnetic field sensors described herein can be designed with an operating range that would measure magnetic field strengths on the low side down to approximately 120 micro-gauss, and on the high side up to approximately 6 gauss. Therefore, the DC field target magnets employed in the detection system disclosed herein may be relatively small, for example, approximately ¼″ diameter by ¾″ long, and having a magnetic field strength of approximately 10,000-13,000 gauss, as measured at the magnet's surface. However, the application outlined above is exemplary only; the shape of the magnet and its size and strength parameters so described should not be considered as a limitation on the scope of this disclosure. It is well understood that the present subject matter also covers devices and systems utilizing both smaller/larger and stronger/weaker target magnets, as well as magnetic field sensors with greater sensitivity and wider operating ranges.

In one illustrative embodiment, the magnet position locator 31 would have an active linear magnet sensing area ranging from about 16 to 80 mm in the forward direction 32, and about ±100 mm in the side-to-side directions 34 and 35. To accommodate such a design, the orthogonal magnetic field sensors 18 and 19, or pairs of single-axis magnetic field sensors 18a, 18b and 19a, 19b, would be mounted along the x-axis 43 of the magnet position locator device 31, and about 64 mm to either side 34 or 35 of the device reference line 28 and desired y-axis 42. The sensors 18 and 19 would therefore be spaced approximately 128 mm from center point 20 to center point 21. As an exponential function of the number 2, the selection of a 128 mm value for the spacing of the field sensors described herein facilitates easier mathematical calculations for the algorithm method described above, with less inherent decimal rounding errors.

It should be noted that, in order to maximize linearity and to minimize any noisy position calculations, an active pair of properly matched and calibrated automatic gain control (AGC) circuits, amplifiers, and/or band pass filters may be used for each of the dual port and starboard amplifiers channels of the magnet position locator device 31. Also, a safeguard that a magnet position locator device 31 might employ is an absolute signal strength detector for each of the port and starboard amplifier channels. Should either of the signal level sums “|Ap|+|Bp|” or “|As|+|Bs|” not rise above a minimum threshold, the detector might be designed to report “no magnet detected”, rather than provide a noisy or an erroneous magnet position. Further, it should be realized that even when the target magnet 38 has a very strong magnetic field 13, such as in the range of 10,000 to 12,000 gauss when measured at the magnet's surface, the magnetic field strength as measured by orthogonal field sensors 18 and 19 may only be in the range of 0.3 to 0.6 gauss, when the magnetic field is initially detected from a distance of about 100 or more mm. Such a measured field strength is on the order of that of the earth's local magnetic field. Consequently, the earth's magnetic field will be seen as a single angular bias to both sets of orthogonal sensors, and it should be calibrated out whenever the magnet position locator 31 changes its orientation (heading) and when it is known that a magnet is not present.

In another embodiment, two single-axis magnetic field sensors may be mounted back-to-back, per sensor axis, in differential mode, so as to increase the magnet position locator's signal-to-noise ratio. Similarly, linear ratio-metric resistive sensors may be excited via an alternating voltage at any one particular frequency, and the four sensor outputs AC coupled, amplified and synchronously demodulated. Such a circuit design may eliminate or at least reduce the relatively high DC gains required for each sensor channel by allowing use of AC coupled amplifier circuits and/or band-pass amplifiers. However, it should be noted in any case that the four-channel magnetic field sensor location algorithms described above can be used via DC amplifier levels or peak rectified or sampled AC levels so as to locate a target magnet 38 relative to the two orthogonal sensors 18 and 19.

The particular embodiments disclosed above are illustrative only, as the invention may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A magnet position locator, comprising:
a first magnetic field sensor positioned at a first point, said first magnetic field sensor comprising a first pair of directionally disposed magnetic field sensing devices, wherein said first pair of directionally disposed magnetic field sensing devices is adapted to sense a magnetic field strength along two differing orientations, wherein said first point is a common mounting point of said first pair of directionally disposed magnetic field sensing devices;
a second magnetic field sensor positioned at a second point, said second magnetic field sensor comprising a second pair of directionally disposed magnetic field sensing devices, wherein said second pair of directionally disposed magnetic field sensing devices is adapted to sense a magnetic field strength along two differing orientations wherein said second point is a common mounting point of said second pair of directionally disposed magnetic field sensing devices; and
a mounting axis defined by a line passing through said first and second points, wherein said first and second magnetic field sensors are spaced a distance apart on said mounting axis.

2. The magnet position locator of claim 1, wherein:
said first and second magnetic field sensors are adapted to obtain a magnetic field strength signal of a magnet;
a center of said magnet is located on a first axis;
said first axis is defined by a line passing through said center of said magnet and intersecting said mounting axis at a third point located on said mounting axis between said first and second points;
said center of said magnet and said third point on said mounting axis are spaced a distance apart on said first axis; and
said first axis is oriented substantially transverse to said mounting axis.

3. The magnet position locator of claim 2, wherein said mounting axis is oriented substantially perpendicular to said first axis.

4. The magnet position locator of claim 2, further comprising a means for computing a position of said magnet from said magnetic field strength signals obtained by said first and second magnetic field sensors.

5. The magnet position locator of claim 1, wherein said two differing orientations of said first pair of directionally disposed magnetic field sensing devices are arranged orthogonally, and said two differing orientations of said second pair of directionally disposed magnetic field sensing devices are arranged orthogonally.

6. The magnet position locator of claim 1, wherein at least one of said first and second pairs of directionally disposed magnetic field sensing devices of said first and second magnetic field sensors comprises one dual-axis magnetic field sensor.

7. The magnet position locator of claim 1, wherein at least one of said first and second pairs of directionally disposed magnetic field sensing devices of said first and second magnetic field sensors comprises a pair of single-axis magnetic field sensors.

8. The magnet position locator of claim 5, wherein a first orientation of said first pair of directionally disposed magnetic field sensing devices is aligned with a third orientation of said second pair of directionally disposed magnetic field sensing devices, and wherein both said first and said third orientations are orthogonal to said mounting axis of said first and second magnetic field sensors.

9. The magnet position locator of claim 5, wherein a second orientation of said first pair of directionally disposed magnetic field sensing devices is aligned with a fourth orientation of said second pair of directionally disposed magnetic field sensing devices, and wherein both said second and said fourth orientations are parallel to said mounting axis of said first and second magnetic field sensors.

10. A magnet position locator, comprising:
at least three spaced apart magnetic field sensors, wherein said at least three spaced apart magnetic field sensors are directionally disposed to sense a magnetic field strength signal along an axis and adapted to obtain a magnetic field strength signal of a magnet, said magnet having a center on a first axis wherein a projection of said first axis is oriented substantially transverse to a mounting axis defined by a line passing through at least two of said at least three spaced apart magnetic field sensors; and
a means for computing a position of said magnet from said magnetic field strength signals obtained by said at least three magnetic field sensors.

11. An automated guided vehicle steering correction system, comprising:
at least one mobile apparatus adapted to travel in a direction, said mobile apparatus comprising a body, said body supported by a plurality of wheels, and said plurality of wheels adapted for moving said body over a surface;
a pair of spaced apart magnetic field sensors, said pair of magnetic field sensors mounted on said body of said mobile apparatus on a mounting axis that is oriented substantially transverse to said direction of travel, wherein each of said pair of magnetic field sensors comprises a pair of directionally disposed magnetic field sensing devices, and wherein each of said pairs of directionally disposed magnetic field sensing devices is adapted to sense a magnetic field strength along two differing orientations;
a pathway for said at least one mobile apparatus; and
at least one magnet disposed along said pathway.

12. The system of claim 11, wherein said pathway comprises a surface, and wherein at least a portion of said at least one magnets is adjacent said surface.

13. The system of claim 11, wherein said mounting axis is oriented substantially perpendicular to said direction of travel.

14. The system of claim 11, wherein said pair of magnetic field sensors are adapted to obtain a magnetic field strength signal of said magnet, wherein a center of said magnet is located a distance away from said mobile apparatus in said direction of travel on a first axis defined by a line passing through said center of said magnet and intersecting said mounting axis of said pair of magnetic field sensors at a point located between said pair of magnetic field sensors.

15. The system of claim 14, wherein said distance away from said mobile apparatus is in a direction forward of said mobile apparatus, and said direction of travel is forward of said mobile apparatus.

16. The system of claim 14, further comprising a means for computing a position of said magnet from said magnetic field strength signals obtained by said pair of magnetic field sensors.

17. The system of claim 16, wherein said mobile apparatus further comprises a means for controllably adjusting the steering of said mobile apparatus, and wherein said steering is controllably adjusted to correct or maintain a heading of said mobile apparatus in a direction of said magnet along said path of intended travel while moving on said pathway.

18. The system of claim 11, wherein said magnet is a cylindrically shaped DC field magnet.

19. The system of claim 11, wherein said two differing orientations of each of said pairs of directionally disposed magnetic field sensing devices are arranged orthogonally.

20. The system of claim 11, wherein at least one of said pairs of directionally disposed magnetic field sensing devices of said pair of magnetic field sensors comprises one dual-axis magnetic field sensor.

21. The system of claim 11, wherein at least one of said pairs of directionally disposed magnetic field sensing devices of said pair of magnetic field sensors comprises a pair of single-axis magnetic field sensors with a common base point.

22. The system of claim 11, wherein a first orientation of each of said pairs of directionally disposed magnetic field sensing devices is orthogonal to said mounting axis of said pair of magnetic field sensors and a second orientation of each of said pairs of directionally disposed magnetic field sensing devices is parallel to said mounting axis.

23. A method for determining the position of a magnet, comprising:
disposing a pair of magnetic field sensors on a mounting axis and separating said pair of magnetic field sensors by a distance, wherein each of said pair of magnetic field sensors is adapted to sense a magnetic field strength of a magnet along two differing sensing orientations, said magnet having a center on a first axis wherein a projection of said first axis intersects said mounting axis at a point between said pair of magnetic field sensors;
sensing a magnetic field strength signal of said magnet using said pair of magnetic field sensors; and
computing a position of said magnet from said magnetic field strength signals by determining an angular relation between each of said magnetic field sensors and said magnet.

24. The method of claim 23, wherein said two differing sensing orientations of each of said pair of magnetic field sensors are arranged orthogonally.

25. The method of claim 23, wherein determining said angular relation between each of said magnetic field sensors and said magnet comprises:
determining a first angular relation between a first of said pair of magnetic field sensors and said magnet; and
determining a second angular relation between the other of said pair of magnetic field sensors and said magnet.
